(19) United States
(12) Patent Application Publication
(10) Pub. No.: US 2006/0094581 A1
(43) Pub. Date: May 4, 2006

(54) Closure device for, and method for closing, bag for food products

(75) Inventor: Paul Jackson, Bells, TN (US)

Correspondence Address: NORMAN H. ZIVIN;Cooper & Dunham LLP, 1185 Avenue of the Americas, New York, NY, 10036, US

(73) Assignee: HB Creative, LLC

(21) Appl. No.: 10/975,903

(22) Filed: Oct. 28, 2004

(51) Int. Cl. B31B 1/86

(52) U.S. Cl. 493/221

(57) ABSTRACT

A bag for granular products, made of heat sealable film, having an integral handle within the top sealed portion of the bag that fits into and is secured within an opening in the bottom sealed portion of the bag, whereby the bag can be securely re-closed after opening by folding the top portion of the bag over toward the bottom portion of the bag, and securing the integral handle within the opening.

### FIELD OF THE INVENTION

This invention relates to an easy-closing device for a bag for granular products that utilizes an integral handle in the top of the bag that fits into and is secured within an opening in the bottom of the bag, whereby the bag is securely re-closed after opening. This invention also relates to a method of closing a bag for granular products.

### BACKGROUND OF THE INVENTION

For many years, bags have been used for packaging granular products, such as frozen vegetables. Typically, such products are not consumed all at once, so that the bag, after being opened, continues to serve as a storage bag for the remaining product to be kept frozen and used at a later date.

It is desirable to have bags which are recloseable or resealable after opening to maintain freshness, and to prevent spillage, of the product within. For example, prior bags used a fastening strip to allow resealing of a bag (See U.S. Pat. Nos. 6,533,711 and 6,053,635, both to Anderson et al.), or a profile strip fastener assembly that includes a pair of releasably interlocking profile strips, analogous to the known Ziploc® bags (See U.S. Pat. Nos. 6,481,891; 6,270,257; 6,079,878; 5,954,433; 5,951,453; and 5,806,984, each to Yeager; U.S. Pat. No. 6,360,513 to Strand et al.; U.S. Pat. No. 6,286,999 to Cappel et al.; U.S. Pat. No. 5,417,040 to Davoren; and U.S. Pat. No. 4,787,755 to Branson). Other bags relied on some form of reclosure tie to reseal a bag (See U.S. Pat. Nos. 6,086,524; 4,787,517; 4,609,107; and 4,549,657, each to Martin; U.S. Pat. No. 5,673,534 to Fowler; and U.S. Pat. No. 4,267,768 to Cieslak et al.).

Other closure devices used to reseal or reclose a bag are as follows: U.S. Pat. Nos. 4,979,933; 4,936,817; and 4,898,280, each to Runge, show a reclosable bag that utilizes a sealing tape overlying a metal strip segment. U.S. Pat. Nos. 6,325,541 and 6,048,100 to Thrall et al. show a flap which extends across the upper end of the bag, and a resealable closure positioned between the flap portion and the front wall of the bag. U.S. Pat. No. 4,824,261 to Provost shows a reclosable bag that utilizes hook and loop sealing strips. U.S. Pat. No. 4,818,120 to Addiego shows a bag that can be reclosed by folding the bag opening and folding tin-ties which overly the end tabs around the folded bag opening. U.S. Pat. No. 4,795,270 to Heyden shows a bag in which the upper marginal region of the bag receives and positionally holds a folded over portion of the bag after opening the bag. U.S. Pat. No. 5,911,508 to Dobreski et al. and U.S. Pat. No. 4,483,445 to Lepisto et al., show other types of reclosable bags.

None of the known bags, however, utilize an integral handle that fits within an opening in the bottom of the bag, such that the bag can be kept in a securely folded position by folding the top of the bag over toward the bottom of the bag, and securing flaps of the integral handle within the opening in the bottom of the bag. Such a closure device is less expensive to produce and easier for a consumer to use than the typical Zipper-like strip, for example, and makes efficient use of an integral handle, which doubles as an easy-locking mechanism.

It is known to manufacture bags from coextruded polyethylene film or laminated film. The manufacturing process includes the step of sealing a bag by applying enough heat to the surface of the bag to melt the material and cause it to adhere to itself. Only the inside layer needs to melt to create the seal; the outer layers must be cooled so that they do not melt and cause the bag to lose its shape.

To avoid the manufacturing problems associated with heat sealing coextruded polyethylene, the packaging industry has used laminated film. Laminated film consists of layers of different material brought together. The layers may consist of such materials as polyethylene, polyester, paper, foil and polypropylene. The outside layer of laminated film consists of a heat resistant material, such as polyester, or is coated with heat resistant material. In either case, the outside layer melts at a higher temperature than the inside layer. A heat seal of the inside layer thus can be effected without causing structural breakdown of the outer layer.

There is a need in the packaging industry to combine the cost advantages of using low cost extruded polyethylene film with the closing mechanism of the present invention, especially to create an inexpensive, easily recloseable bag for food or other granular products.

### SUMMARY OF THE INVENTION

It is therefore an object of the present invention to provide a bag for granular products, made of heat sealable film, having an integral handle within the top sealed portion of the bag that fits into and is secured within an opening in the bottom sealed portion of the bag, whereby the bag can be securely re-closed after opening by folding the top portion of the bag over toward the bottom portion of the bag, and securing the integral handle within the opening.

It is a further object of the present invention to provide a method for closing a bag for granular products, made of heat sealable film, which incorporates an integral handle, and is less expensive to produce than other typical resealing features, such as a zipper-like strip.

The foregoing objects are achieved and the disadvantages of the known bag designs are overcome by providing a bag in accordance with the present invention. The bag includes front and rear walls, two side walls, a top portion, a bottom portion, an integral handle in the top portion, and an opening in the bottom portion into which the integral handle fits.

The term “walls” is meant to be broad enough to include a bag design resembling a pouch, whereby the rear, top and bottom portions are sealed, but the overall structure lacks defined corners or folds.

The heat sealable film preferably is an extruded, blown or cast polyethylene film that can be coextruded from various formulations such as Low Density Polyethylene (LDPE), Linear Low Density Polyethylene (LLDPE), metallocene or single site catalyzed polyolefins or plastomers, High Density Polyethylene (HDPE), polypropylene, polypropylene co-polymers, polyethylene co-polymers, or blends of the LDPE, LLDPE, metallocene or single site catalyzed polyolefins or plastomers, HDPE, polypropylene, polypropylene co-polymers, and polyethylene co-polymers, in combination with coatings to yield a multi-layer film. The film can be extruded on a single or multi-layer blown film line. The object is to produce a film having an inside layer which can be sealed at lower temperatures than outer/exterior layers. More specifically, the inside layer has a lower melting point and, in turn, a lower seal initiation point than the outer layers.

The heat sealable film is structurally rigid to prevent stretching and distortion of the film during the heat sealing process. The extruded film is designed to have a hot tack (i.e., strength a material has in molten state) which is higher in the inside layer than in the outer layer. A high hot tack enables the inside layer to hold the weight of a product poured into the bag during filling.

When the bag is formed, both the top portion and bottom portion of the bag are heat-sealed. An integral handle is cut into the top heat seal of the bag. The integral handle is formed by cutting a predetermined pattern into the top heat seal. For example, and in particular, cutting a C-shaped pattern into the top heat seal produces an integral handle that consists of a flap with two ear-like lobes. An opening is then cut into the bottom heat seal of the bag, just wide enough for the integral handle to fit into, such that the ear-like lobes keep the flap secure within the opening.

The bag can be formed on a Vertical Form, Fill and Seal (VFFS) bag machine. Essentially, a single piece of heat sealable film, having top and bottom edges and first and second side edges, is wrapped around a tube to continuously form the front wall, the two side walls, and the rear wall. The first and second side edges are heat sealed to each other to close the rear wall. The bottom edge is heat sealed to seal the bottom portion, at which time the opening is also cut into the bottom seal. The bag is filled with a predetermined material. Finally, the top edge is heat sealed to seal the top portion of the bag, and the integral handle is cut into the top seal. It should be noted that the VFFS can be used to simultaneously seal the top seal of a first bag and cut the integral handle therein, and seal the bottom seal of a next adjacent bag and cut the opening therein.

### BRIEF DESCRIPTION OF THE DRAWINGS

The features and advantages of the invention will become apparent upon review of the following detailed description of the preferred embodiment, taken in conjunction with the following drawings, in which:

FIG. 1 is a front view of a bag according to the preferred embodiment of the present invention;

FIG. 2 is a rear view of a bag according to the preferred embodiment of the present invention;

FIG. 3 is a right side view of a bag according to a preferred embodiment of the present invention;

FIG. 4 is a left side view of a bag according to the preferred embodiment of the present invention;

FIG. 5 is a perspective view of a bag according to the preferred embodiment of the present invention;

FIG. 6 is a front view of a bag according to the preferred embodiment of the present invention;

FIG. 7 is a front perspective view of a bag being folded and closed according to the preferred embodiment of the present invention; and

FIG. 8 is a rear perspective view of a bag that has been fully folded and closed according to the preferred embodiment of the present invention.

### DETAILED DESCRIPTION

The present invention relates to a bag for granular products, such as foods or the like, manufactured from an extruded heat sealable material and having both an integral handle in the top portion of the bag and an opening in the bottom portion of the bag in which the handle fits to secure the bag in a folded position, thereby optimizing the freshness and retention of the product within the bag.

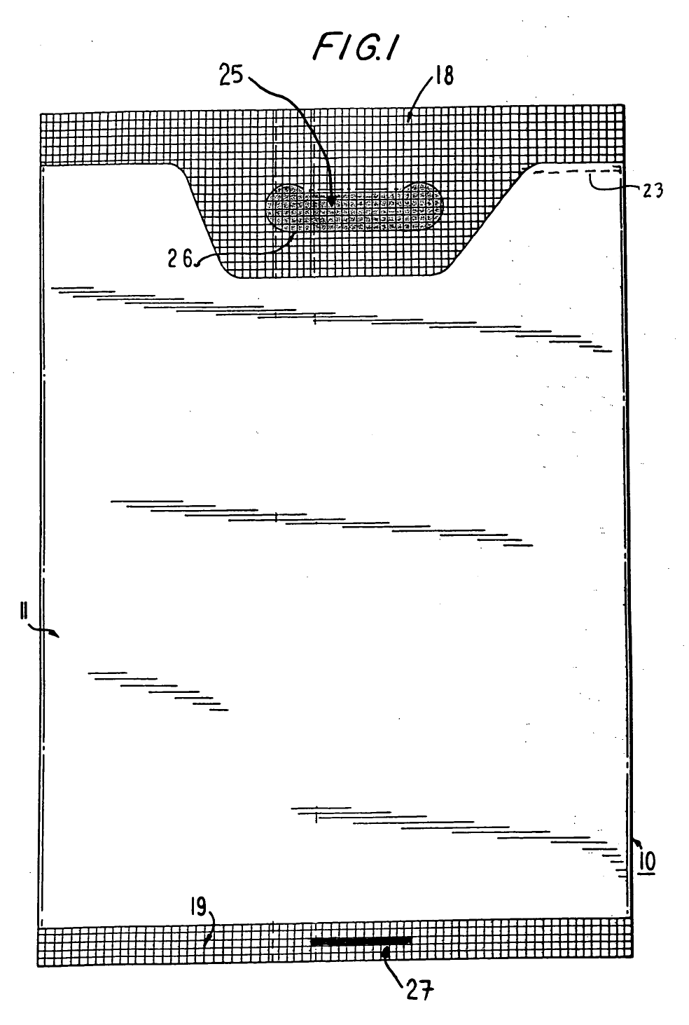

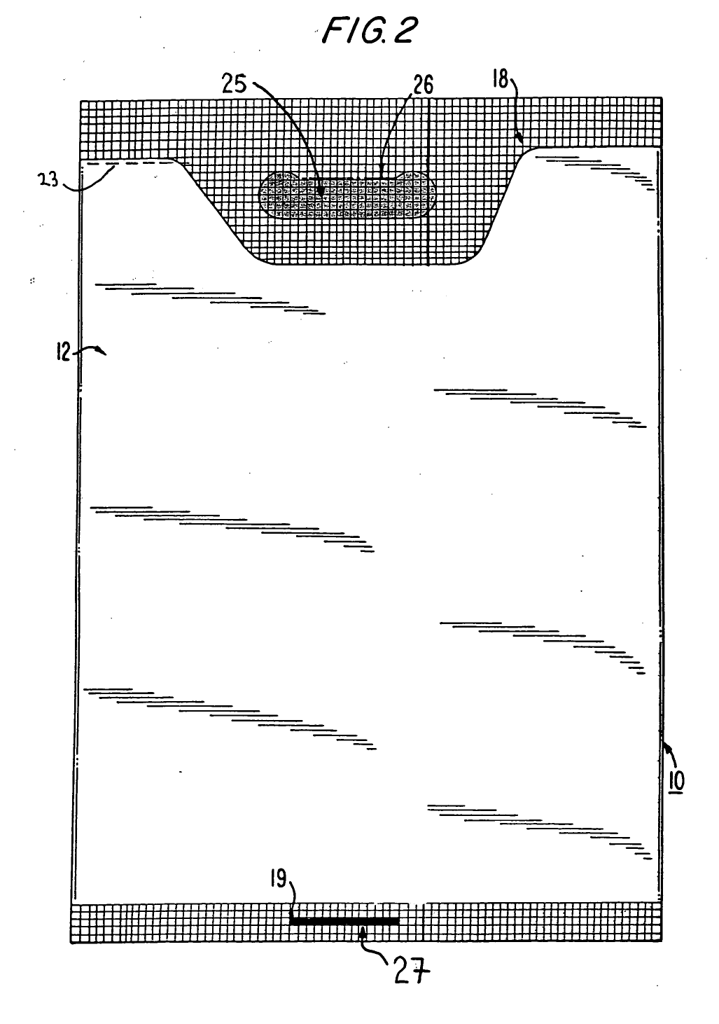

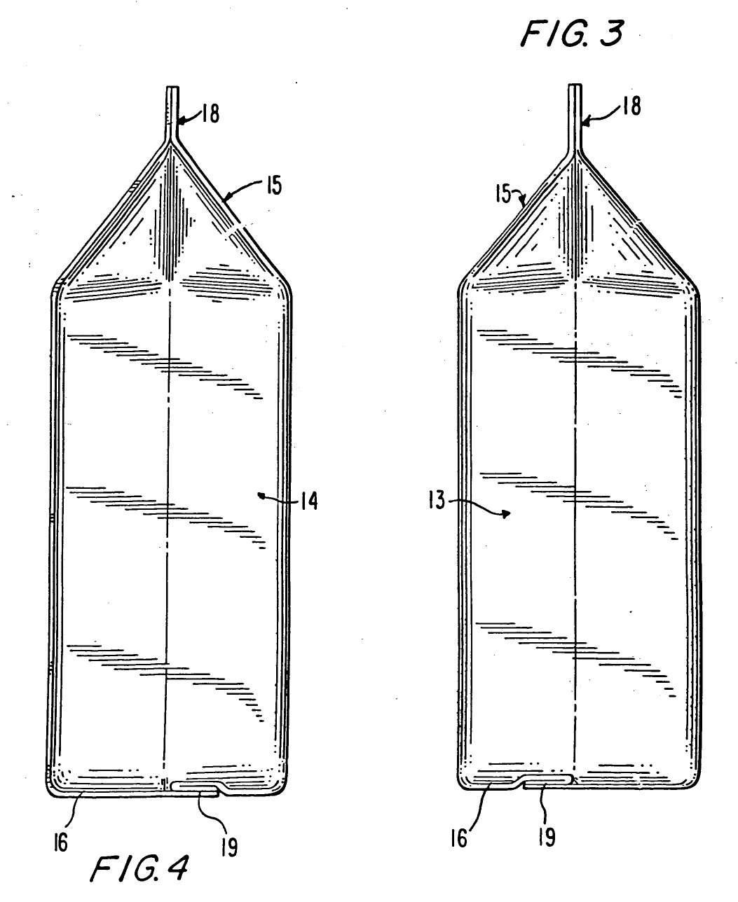

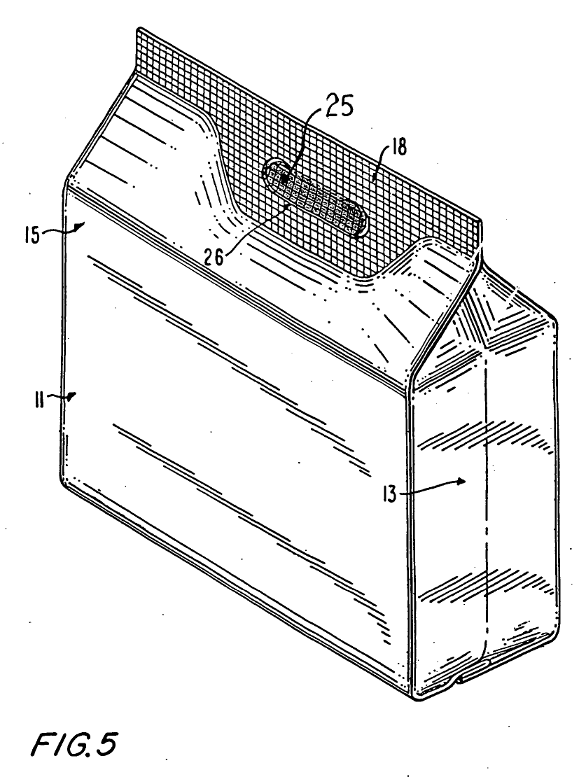

As shown in FIGS. 1-5, in a preferred embodiment of the present invention, a bag 10 includes a front wall 11, a rear wall 12, a side wall 13, a side wall 14, a top portion 15, a bottom portion 16, a top portion heat seal 18, a bottom portion heat seal 19, an integral handle 25 formed by a cut-out pattern 26 in the top portion heat seal 18, and an opening 27 formed in the bottom portion heat seal 19. The top portion heat seal 18 and the bottom portion heat seal 19 may be corrugated for added beam strength. The side walls may form gussets.

The bag 10 can be used to package a variety of consumer products, including frozen vegetables, such as peas, carrots and corn, frozen fruits and meats, popcorn, and the like.

The top portion 15 includes an integral handle 25 which can be cut into or formed in the top portion heat seal 18. As shown in FIGS. 1,2 and 5, integral handle 25 is formed in a C-shaped pattern 26 into the top portion heat seal 18. The handle 25 permits a consumer to carry the bag 10 without getting his or her hands cold when placing the bag 10 in or taking the bag 10 out of a freezer.

A series of perforations 23 may be cut into the top portion of the bag to create a tear strip for opening the bag.

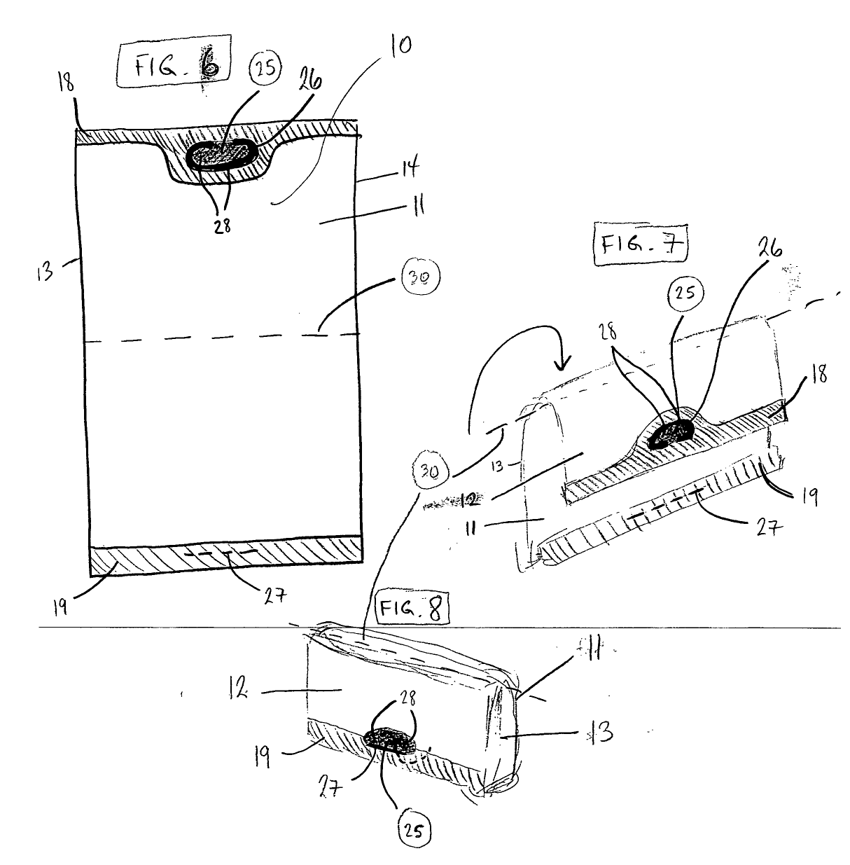

As shown in FIGS. 6-8, the bag 10 can be reclosed or resealed after opening by folding the bag 10 along a midsection line 30, such that the integral handle 25 can fit into the opening 27. More specifically, ear lobes 28 of the integral handle 25 are securely fitted into the opening 27 and press against the rear wall 12, maintaining the bag 10 in a folded and sealed position.

The bag 10 is made of heat sealable film, which is a blown, cast or extruded film that can be extruded or coextruded from various formulations, such as Low Density Polyethylene (LDPE), Linear Low Density Polyethylene (LLDPE), metallocene or single site catalyzed polyolefins or plastomers, High Density Polyethylene (HDPE), polypropylene, polypropylene co-polymers, polyethylene co-polymers, or blends of the LDPE, LLDPE, metallocene or single site catalyzed polyolefins or plastomers, HDPE, polypropylene, polypropylene co-polymers, and polyethylene co-polymers, in combination with coatings, to yield a multi-layer film. Of course, other suitable packaging materials also may be used. The material also may be biodegradable. The film can be coextruded on a multi-layer blown film line; the film can also be extruded as a single layer on a blown film line.

The heat sealable film is manufactured with an inside layer that has a lower seal initiation temperature than the outer layer. Heat must be applied to the outer layer at a temperature higher than the melting point of the inside layer to create the top portion heat seal 18 and the bottom portion heat seal 19, out of which the integral handle 25 and the opening 27 may be cut.

The film used is structurally rigid and puncture-resistant to prevent stretching and distorting the film during the heat sealing process and to maintain the package shape during shipping, handling and display of the bag 10. The extruded film is designed to have a hot tack which is higher in the inner layer than in the outer layer. A high hot tack enables molten inside layers to hold the weight of a product poured into the bag 10 during filling. A low hot tack in the outer layer prevents sealing jaws from sticking to the outer layer.

The preferred embodiments described above are illustrative of the invention, which is not limited to the embodiment described. Various changes and modifications may be made in the invention by one skilled in the art without departing from the spirit or scope of the invention.

What is claimed is:

1. A bag formed of a heat sealable film, comprising:
front and rear walls;
two side walls;
a top portion;
a bottom portion;
an integral handle in the top portion;
and an opening in the bottom portion into which the integral handle can fit when the top portion of the bag is folded over toward the bottom portion of the bag.

2. The bag according to claim 1, wherein the opening is a cut slot.

3. The bag according to claim 1, wherein the front and rear walls are heat-sealed at a top edge and a bottom edge.

4. The bag according to claim 3, wherein the integral handle is formed in the heat-sealed top edge.

5. The bag according to claim 3, wherein the opening is formed in the heat-sealed bottom edge.

6. The bag according to claim 3, wherein the heat-sealed top and bottom edges are corrugated.

7. The bag according to claim 1, wherein the integral handle is formed by cutting a predetermined pattern in the top portion.

8. The bag according to claim 7, wherein the predetermined pattern is a C-shaped pattern such that the handle forms a flap with two ear lobes.

9. The bag according to claim 1, wherein the heat sealable film is extruded from a group consisting essentially of Low Density Polyethylene (LDPE), Linear Low Density Polyethylene (LLDPE), metallocene or single site catalyzed polyolefins or plastomers, High Density Polyethylene (HDPE), polypropylene, polypropylene co-polymers, polyethylene co-polymers, or blends of the LDPE, LLDPE, metallocene or single site catalyzed polyolefins or plastomers, HDPE, polypropylene, polypropylene co-polymers, and polyethylene co-polymers.

10. The bag according to claim 1, wherein the heat sealable film is a multi-layer film.

11. The bag according to claim 1, wherein the heat sealable film is structurally rigid.

12. The bag according to claim 1, wherein the heat sealable film is coextruded on a multi-layer blown or cast film line.

13. The bag according to claim 1, wherein the heat sealable film has an inside layer and an outer layer, the inside layer having a lower seal initiation point than the outer layer.

14. The bag according to claim 1, wherein the heat sealable film has an inside layer and an outer layer, the inside layer having a higher hot tack than the outer layer.

15. The bag according to claim 1, wherein the bag is formed on a Vertical Form, Fill and Seal bag machine.

16. The bag according to claim 1, wherein simultaneously the top portion of the bag is heat sealed and the integral handle is formed in the top portion of the bag; the bottom portion of a next adjacent bag is heat sealed and the opening is formed in the bottom portion of the next adjacent bag; and the bag is displaced from the next adjacent bag.

17. The bag according to claim 1, wherein the side walls form gussets.

18. A method for closing a bag formed of a heat sealable film and having front and rear walls, two side walls, a top portion, a bottom portion, an integral handle in the top portion, and an opening in the bottom portion, comprising the steps of:
folding the top portion of the bag over toward the bottom portion of the bag; and
inserting the integral handle into the opening.

19. The method according to claim 18, further comprising forming the opening by cutting a slot in the bottom portion.

20. The method according to claim 18, further comprising forming the integral handle by cutting a predetermined pattern in the top portion.

21. The method according to claim 20, wherein the predetermined pattern is a C-shaped pattern such that the handle forms a flap with two ear lobes.

22. The method according to claim 21, wherein the bag is closed by folding the top portion of the bag over toward the bottom portion, and extending the ear lobes into the opening, whereby the flap is secured within the opening, thereby maintaining the bag in a folded position.
